(19) United States
(12) Patent Application Publication
(10) Pub. No.: US 2023/0093081 A1
(43) Pub. Date: Mar. 23, 2023

(54) POSITIVE ELECTRODES INCLUDING ELECTRICALLY CONDUCTIVE CARBON ADDITIVES

(71) Applicant: GM GLOBAL TECHNOLOGY OPERATIONS LLC, Detroit, MI (US)

(72) Inventors: Bradley R. Frieberg, Farmington Hills, MI (US); Xiaosong Huang, Novi, MI (US); Nicole Ellison, Madison Heights, MI (US); Roland J. Koestner, Rochester Hills, MI (US)

(73) Assignee: GM GLOBAL TECHNOLOGY OPERATIONS LLC, Detroit, MI (US)

(21) Appl. No.: 17/476,833

(22) Filed: Sep. 16, 2021

(51) Int. Cl. H01M 4/62; H01M 4/525; H01M 4/505; H01M 10/0525; H01M 4/583

(52) U.S. Cl. CPC H01M 4/623; H01M 4/625; H01M 4/525; H01M 4/505; H01M 10/0525; H01M 4/583; H01M 2004/028

(57) ABSTRACT

A positive electrode including positive electrode active material particles, a polymeric binder, a polymeric dispersant, and a combination of electrically conductive carbon additive types. The combination of electrically conductive carbon additive types includes carbon particles, graphene sheet stacks, and carbon nanotubes.

### INTRODUCTION

The present disclosure relates to electrodes of secondary lithium batteries and, more particularly, to composite positive electrodes that include a combination of electrically conductive carbon additive types.

A battery is a device that converts chemical energy into electrical energy by means of electrochemical reduction-oxidation (redox) reactions. In secondary or rechargeable batteries, these electrochemical reactions are reversible, which allows the batteries to undergo multiple charging and discharge cycles.

Secondary lithium batteries include one or more electrochemical cells that operate by reversibly passing lithium ions between electrochemically active materials of a negative electrode and a positive electrode. A polymeric separator may be sandwiched between the negative and positive electrodes to physically separate and electrically isolate the electrodes from each other in the electrochemical cell. The negative and positive electrodes and the polymeric separator are typically porous and infiltrated with an ionically conductive electrolyte that provides a medium for the conduction of lithium ions therethrough. Movement of the positively charged lithium ions through the polymeric separator between the negative and positive electrodes of the electrochemical cell is balanced by the simultaneous movement of electrons. Unlike the lithium ions, however, the electrons travel between the negative and positive electrodes via an external circuit. The negative and positive electrodes are oftentimes electrically coupled to the external circuit via respective negative and positive electrode current collectors.

The negative and positive electrodes are formulated such that an electrochemical potential is established therebetween when the negative and positive electrodes are ionically connected to each other, for example, by being submerged in an ionically conductive electrolyte, and are electrically coupled to each other via an external circuit. During discharge, the electrochemical potential established between the negative and positive electrodes drives spontaneous redox reactions within the electrochemical cell and the release of lithium ions and electrons at the negative electrode. The released lithium ions travel from the negative electrode to the positive electrode through the ionically conductive electrolyte, and the electrons travel from the negative electrode to the positive electrode via the external circuit, which generates an electric current. After the negative electrode has been partially or fully depleted of lithium, the electrochemical cell may be recharged by connecting the negative and positive electrodes to an external power source, which drives nonspontaneous redox reactions within the electrochemical cell and the release of the lithium ions and the electrons from the positive electrode.

The negative and positive electrodes are oftentimes deposited on their respective current collectors in the form of a composite layer that includes particles of an electrochemically active material, a binder, and an electrically conductive additive. The binder may provide the negative and positive electrode layers with structural integrity and the electrically conductive additive may form an electrically conductive network that facilitates transport of electrons through the electrode layers (between the electrochemically active material particles and the current collector). To actively participate in the electrochemical redox reactions occurring within the electrochemical cell, each electrochemically active material particle must be: (i) in physical contact with the ionically conductive electrolyte, and (ii) directly or indirectly electrically connected to its associated current collector. Increasing the number of electrochemically active material particles within the negative and positive electrode layers available to actively participate in the electrochemical redox reactions occurring within the electrochemical cell can increase the charge and discharge capacity of the electrochemical cell. Improving the electrical and ionic conductivity of the negative and positive electrode layers, for example, by creating more robust and less tortuous electron and lithium-ion transport pathways through the electrode layers, may help improve the charge and discharge rate capability of the electrochemical cell.

### SUMMARY

A positive electrode is disclosed that comprises positive electrode active material particles, a polymeric binder, a polymeric dispersant, and a combination of electrically conductive carbon additive types. The combination of electrically conductive carbon additive types includes carbon particles, graphene sheet stacks, and carbon nanotubes.

The carbon particles may comprise particles of carbon black and/or acetylene black and may exhibit a mean particle diameter in a range of from 2 nanometers to 100 nanometers.

The carbon nanotubes may include single-walled carbon nanotubes and/or multiwalled carbon nanotubes. The carbon nanotubes may include hydroxyl (—OH) functional groups and/or carboxyl (—COOH) functional groups.

The graphene sheet stacks may comprise graphite flakes. In such case, the graphite flakes may exhibit an aspect ratio in a range of from 1 to 3.

The graphene sheet stacks may comprise graphene nanoplatelets.

The carbon particles may exhibit an aspect ratio of about one, the graphene nanoplatelets may exhibit an aspect ratio of greater than 20, and the carbon nanotubes may exhibit an aspect ratio of greater than 100.

The combination of electrically conductive carbon additive types may account for, by weight, 0.5% to 10% of the positive electrode.

The carbon particles may account for, by weight, 0.25% to 10% of the positive electrode, the graphene sheet stacks may account for, by weight, 0.1% to 10% of the positive electrode, and the carbon nanotubes may account for, by weight, 0.05% to 5% of the positive electrode.

The polymeric binder may comprise polyvinylidene fluoride. The polymeric binder may account for, by weight, 0.5% to 10% of the positive electrode.

The polymeric dispersant may comprise at least one polymer selected from the group consisting of a polytetrafluoroethylene and polyvinylidene fluoride copolymer, a sulfophenylated terphenylene copolymer, polyvinylpyrrolidone, or polyvinylpyridine. The polymeric dispersant may account for, by weight, 0.1% to 10% of the positive electrode.

The positive electrode active material particles comprise at least one metal oxide selected from the group consisting of lithium nickel manganese cobalt oxide, lithium manganese oxide, lithium nickel cobalt manganese aluminum oxide, lithium iron phosphate, or lithium manganese iron phosphate. The positive electrode active material particles may exhibit a mean particle diameter in a range of from 0.2 micrometers to 25 micrometers. The positive electrode active material particles may account for, by weight, 70% to 98.9% of the positive electrode.

An electrochemical cell for a lithium battery is disclosed. The electrochemical cell comprises a positive electrode disposed on a major surface of a positive electrode current collector. The positive electrode includes positive electrode active material particles, a polymeric binder, a polymeric dispersant, and a combination of electrically conductive carbon additive types. The combination of electrically conductive carbon additive types includes carbon black particles, graphene nanoplatelets, and carbon nanotubes. The positive electrode active material particles, the polymeric binder, the polymeric dispersant, and the combination of electrically conductive carbon additive types are substantially homogenously distributed throughout the positive electrode.

The carbon black particles may exhibit an aspect ratio of about one, the graphene nanoplatelets may exhibit an aspect ratio of greater than 20, and the carbon nanotubes may exhibit an aspect ratio of greater than 100.

The carbon black particles may account for, by weight, 0.25% to 10% of the positive electrode, the graphene nanoplatelets may account for, by weight, 0.1% to 10% of the positive electrode, and the carbon nanotubes may account for, by weight, 0.05% to 5% of the positive electrode.

The polymeric binder may comprise polyvinylidene fluoride. The polymeric binder may account for, by weight, 0.5% to 10% of the positive electrode.

The polymeric dispersant may comprise at least one polymer selected from the group consisting of a polytetrafluoroethylene and polyvinylidene fluoride copolymer, a sulfophenylated terphenylene copolymer, polyvinylpyrrolidone, or polyvinylpyridine. The polymeric dispersant may account for, by weight, 0.1% to 10% of the positive electrode.

The positive electrode active material particles may comprise at least one metal oxide selected from the group consisting of lithium nickel manganese cobalt oxide, lithium manganese oxide, lithium nickel cobalt manganese aluminum oxide, lithium iron phosphate, or lithium manganese iron phosphate. The positive electrode active material particles may account for, by weight, 70% to 98.9% of the positive electrode.

The positive electrode current collector may comprise aluminum, the positive electrode may be disposed on the major surface of the positive electrode current collector in the form of a continuous layer, the positive electrode may exhibit a porous structure including a plurality of open pores, and the open pores of the positive electrode may be infiltrated with an ionically conductive nonaqueous liquid electrolyte

An electrochemical cell for a lithium battery is disclosed. The electrochemical cell comprises a positive electrode exhibiting a porous structure and including a plurality of open pores, a negative electrode spaced apart from the positive electrode, and an electrolyte infiltrating the open pores of the positive electrode. The positive electrode is disposed on a major surface of a positive electrode current collector. The electrolyte provides a medium for conduction of lithium ions between the positive electrode and the negative electrode. The positive electrode includes positive electrode active material particles, a polymeric binder, a polymeric dispersant, and a combination of electrically conductive carbon additive types. The positive electrode active material particles include at least one metal oxide selected from the group consisting of lithium nickel manganese cobalt oxide, lithium manganese oxide, lithium nickel cobalt manganese aluminum oxide, lithium iron phosphate, or lithium manganese iron phosphate. The polymeric binder includes polyvinylidene fluoride. The polymeric dispersant includes at least one polymer selected from the group consisting of a polytetrafluoroethylene and polyvinylidene fluoride copolymer, a sulfophenylated terphenylene copolymer, polyvinylpyrrolidone, or polyvinylpyridine. The combination of electrically conductive carbon additive types includes carbon black particles, graphene nanoplatelets, and carbon nanotubes. The combination of electrically conductive carbon additive types accounts for, by weight, 0.5% to 10% of the positive electrode.

The negative electrode may be disposed on a major surface of a copper current collector. The negative electrode may comprise graphite, silicon, or a nonporous lithium metal layer. The positive electrode current collector may comprise aluminum. The electrolyte may be an ionically conductive nonaqueous liquid solution including a lithium salt dissolved in a nonaqueous aprotic organic solvent.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

Illustrative embodiments will hereinafter be described in conjunction with the appended drawings, wherein like designations denote like elements, and wherein:

FIG. 1 is a schematic side cross-sectional view of an electrochemical cell of a secondary lithium battery, including a positive electrode and a negative electrode spaced apart from one another by a porous separator.

FIG. 2 is a schematic side cross-sectional view of the positive electrode of FIG. 1.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

The presently disclosed positive electrode includes positive electrode active material particles, a binder, a dispersant, and a trio of electrically conductive carbon additive types, with each type of electrically conductive carbon additive in the trio exhibiting a unique physical geometry different from that of the other types of electrically conductive carbon additives in the trio. Without intending to be bound by theory, it is believed that the presently disclosed trio of electrically conductive carbon additive types synergistically improves the electrical percolation and conductivity of the positive electrode, as compared to positive electrodes that do not include the presently disclosed trio of electrically conductive carbon additive types. In addition, the trio of electrically conductive carbon additive types lowers the charge transfer resistance at the surface of the positive electrode active material, without inhibiting the ionic conductivity of the positive electrode.

As used herein, the term “electrical percolation” refers to the formation of an electrically conductive network within the positive electrode that renders the positive electrode electrically conductive (instead of electrically insulating) and allows electrons to diffuse, penetrate, and spread throughout the positive electrode and participate in electrochemical redox reactions occurring therein.

The word “about” means plus or minus 5% of the stated number.

The word “substantially” does not exclude “completely.” For example, a composition which is “substantially free” from Y may or may not be completely free from Y.

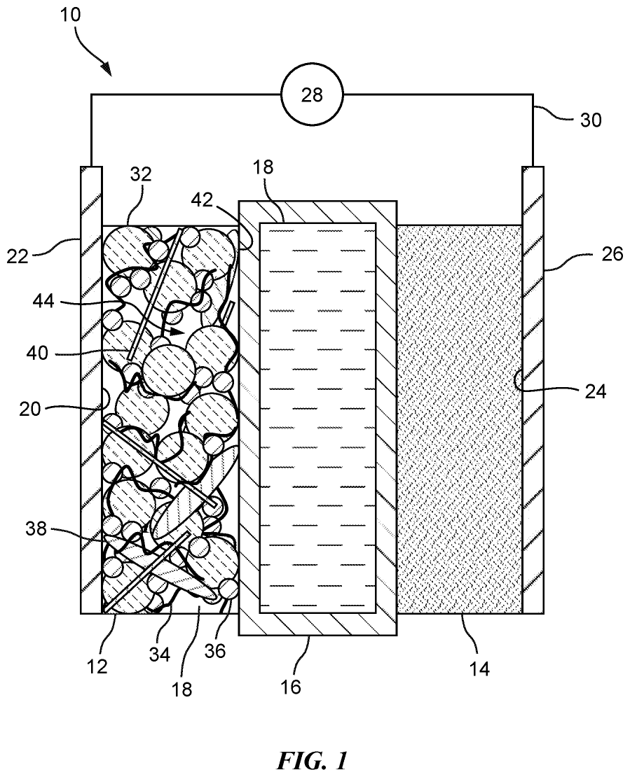

FIG. 1 depicts a schematic side cross-sectional view of an electrochemical cell 10 that may be combined with one or more additional electrochemical cells to form a secondary lithium battery (not shown), such as a lithium-ion battery or a lithium metal battery. The electrochemical cell 10 includes a positive electrode 12, a negative electrode 14 spaced apart from the positive electrode 12, and a porous separator 16 sandwiched between the positive and negative electrodes 12, 14. The positive and negative electrodes 12, 14 and the porous separator 16 are infiltrated with an electrolyte 18 that provides a medium for the conduction of lithium ions therethrough. The positive electrode 12 is disposed on a major surface 20 of a positive electrode current collector 22, and the negative electrode 14 is disposed on a major surface 24 of a negative electrode current collector 26. In practice, the positive and negative electrode current collectors 22, 26 may be electrically coupled to a power source or load 28 via an external circuit 30.

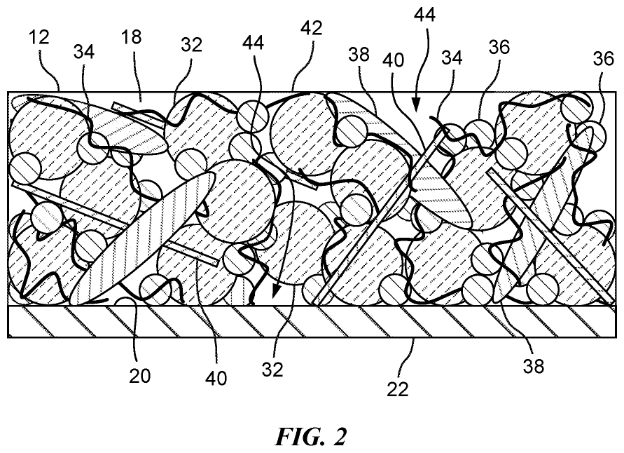

The positive electrode 12 is formulated to store and release lithium ions by undergoing a reversible redox reaction with lithium during discharge and recharge of the electrochemical cell 10. As best shown in FIG. 2, the positive electrode 12 exhibits a porous structure and is a composite of positive electrode active material particles 32, a binder 34, a dispersant (not shown), and a combination of electrically conductive carbon additive types (36, 38, 40). In assembly, the positive electrode 12 is disposed on the major surface 20 of a positive electrode current collector 22 in the form of a continuous uniform layer of material, and open pores 44 defined by the porous structure of the positive electrode 12 are infiltrated with the electrolyte 18. The positive electrode 12 may have a thickness, measured from the major surface 20 of the positive electrode current collector 22 to a facing surface 42 thereof, in a range of from 5 micrometers to 600 micrometers. The positive electrode active material particles 32, the binder 34, the dispersant, and the combination of electrically conductive carbon additive types are substantially homogenously distributed throughout the positive electrode 12 on the major surface 20 of a positive electrode current collector 22.

The positive electrode active material particles 32 are made of a material that can undergo a reversible redox reaction with lithium, e.g., a material that can undergo lithium intercalation and deintercalation, alloying and dealloying, or plating and stripping. In aspects, the positive electrode active material particles 32 may comprise an intercalation host material that can undergo the reversible insertion or intercalation of lithium ions. In such case, the intercalation host material may comprise a layered oxide represented by the formula LiMeO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). For example, the positive electrode active material particles 32 may comprise lithium nickel manganese cobalt oxide (LiNiMnCoO₂), lithium cobalt oxide (LiCoO₂), lithium manganese oxide (LiMn₂O₄), lithium nickel cobalt manganese aluminum oxide (LiNiCoMnAlO₂), lithium iron phosphate (LiFePO₄), and/or lithium manganese iron phosphate (LiMnₓFe₁₋ₓPO₄). In aspects, the positive electrode active material particles 32 may comprise a conversion material that can undergo a reversible electrochemical reaction with lithium, wherein the conversion material undergoes a phase change or a change in crystalline structure accompanied by a change in oxidation state. Example conversion materials include sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. When the conversion material is a metal compound of one or more of the above elements, the metal may be iron, manganese, nickel, copper, and/or cobalt.

The positive electrode active material particles 32 may be porous, substantially spherical, and may exhibit a mean particle diameter in a range of ≥0.2 micrometers to ≤100 micrometers. In aspects, the positive electrode active material particles 32 may exhibit a mean particle diameter in a range of from 0.2 micrometers to 25 micrometers or from 5 micrometers to 20 micrometers. The positive electrode active material particles 32 may account for, by weight, from 70% to 98.9% of the positive electrode 12, from 90% to 98% of the positive electrode 12, or from 95% to 98% of the positive electrode 12. In aspects, the positive electrode active material particles 32 may account for, by weight, about 97% of the positive electrode 12.

The binder 34 is formulated to provide the positive electrode 12 with structural integrity, for example, by creating cohesion between the positive electrode active material particles 32 and the electrically conductive carbon additive types in the positive electrode 12, and by adhering the positive electrode 12 to the major surface 20 of the positive electrode current collector 22. The binder 34 may be made of a polymeric material. Examples of polymeric materials for the binder 34 include polyvinylidene fluoride (PVdF), polyvinylidene fluoride copolymers, ethylene propylene diene monomer (EPDM) rubber, styrene butadiene rubber (SBR), carboxymethyl cellulose (CMC), polyacrylic acid, and combinations thereof. In aspects, the binder 34 may consist essentially of polyvinylidene fluoride. The binder 34 may account for, by weight, from 0.5% to 10% of the positive electrode 12, from 0.5% to 5% of the positive electrode 12, or from 0.5% to 2.5% of the positive electrode 12. In aspects, the binder 34 may account for, by weight, about 1.2% of the positive electrode 12.

The dispersant is formulated to help uniformly disperse and stabilize the positive electrode active material particles 32 and the electrically conductive carbon additive types throughout the positive electrode 12, for example, by preventing agglomeration thereof. The dispersant may be a polymeric dispersant. Examples of polymeric dispersants include a polytetrafluoroethylene and polyvinylidene fluoride copolymer, sulfophenylated terphenylene copolymers, polyvinylpyrrolidone, and/or polyvinylpyridine. The dispersant may account for, by weight, from 0.1% to 10% of the positive electrode 12, from 0.1% to 5% of the positive electrode 12, or from 0.1% to 2.5% of the positive electrode 12. In aspects, the dispersant may account for, by weight, about 0.3% of the positive electrode 12.

The combination of electrically conductive carbon additive types in the positive electrode 12 helps optimize the electrical percolation and conductivity of the positive electrode 12, for example, by forming a robust electrically conductive network within the positive electrode 12, which may, in turn, increase the charge and discharge rate capability of the positive electrode 12. The combination of electrically conductive carbon additive types in the positive electrode 12 includes carbon particles 36, graphene sheet stacks 38, and/or carbon nanotubes 40. In aspects, the positive electrode 12 may include a combination of carbon particles 36, graphene sheet stacks 38, and carbon nanotubes 40. The combination of electrically conductive carbon additive types may account for, by weight, from 0.5% to 10% of the positive electrode 12, from 0.5% to 5% of the positive electrode 12, or from 0.5% to 2.5% of the positive electrode 12. In aspects, the combination of electrically conductive carbon additive types may account for, by weight, about 1.5% of the positive electrode 12. In aspects, the carbon particles 36 may account for, by weight, from 40% to 60% of the combination of electrically conductive carbon additive types, the graphene sheet stacks 38 may account for, by weight, from 30% to 40% of the combination of electrically conductive carbon additive types, and the carbon nanotubes 40 may account for, by weight, from 5% to 15% of the combination of electrically conductive carbon additive types in the positive electrode 12.

The carbon particles 36 in the positive electrode 12 may be substantially amorphous, microporous, and spherical, and may exhibit an aspect ratio of about one (1) to about two (2). The carbon particles 36 may comprise, by weight, greater than 96% carbon and may comprise particles of carbon black and/or acetylene black. The carbon particles 36 may exhibit a porosity of about 75%. The mean particle diameter of the carbon particles 36 in the positive electrode 12 may be in a range of from 2 nanometers to 100 nanometers. In aspects, the carbon particles 36 may exhibit a mean particle diameter of about 40 nanometers. The carbon particles 36 may exhibit a surface area in a range of from 10 m²/g to 500 m²/g and an electrical conductivity in a range of from 0.5 S/cm to 50 S/cm. The carbon particles 36 may account for, by weight, from 0.25% to 10% of the positive electrode 12, from 0.25% to 5% of the positive electrode 12, or from 0.25% to 2.5% of the positive electrode 12. In aspects, the carbon particles 36 may account for, by weight, about 0.8% of the positive electrode 12.

Without intending to be bound by theory, it is believed that the carbon particles 36 (which may exhibit a relatively small mean particle diameter and a relatively small aspect ratio compared to the graphene sheet stacks 38 and carbon nanotubes 40) may provide the positive electrode 12 with good local electrical percolation and conductivity at and along the surfaces of the positive electrode active material particles 32. The presence of the carbon particles 36 at and along the surfaces of the positive electrode active material particles 32 may help facilitate intimate contact between lithium ions dissolved in the electrolyte 18 and the positive electrode active material particles 32, which may help increase the charge transfer rate of the positive electrode 12.

The graphene sheet stacks 38 include at least two graphene sheets stacked one on top of the other. Each graphene sheet consists of a single layer of carbon atoms arranged in a honeycomb lattice. In aspects, the graphene sheet stacks 38 may be in the form of graphite flakes and may include greater than 10 graphene sheets or greater than 20 graphene sheets stacked one on top of the other. In other aspects, the graphene sheet stacks 38 may be in the form of graphene nanoplatelets that exhibit a discoid or lenticular shape and are made up of stacks of less than or equal to 10 graphene sheets. In aspects, the graphene nanoplatelets may be made up of stacks of greater than 2 and less than or equal to 10 graphene sheets. When the graphene sheet stacks 38 are in the form of graphene nanoplatelets, the graphene nanoplatelets may exhibit an aspect ratio of greater than or equal to about 20, or an aspect ratio of greater than or equal to about 100, with diameters in a range of from about 1 micrometer to 25 micrometers and thicknesses in a range of from 5 nanometers to 100 nanometers. In aspects, the graphene nanoplatelets may exhibit diameters of about 5 micrometers. The graphene nanoplatelets may exhibit a porosity of about 90%, a surface area in a range of from 10 m²/g to 200 m²/g, an electrical conductivity measured in a direction perpendicular to a major surface thereof of about 10² S/cm, and an electrical conductivity measured in a direction parallel to a major surface thereof of about 10'S/cm. The graphene sheet stacks 38 may account for, by weight, from 0.1% to 10% of the positive electrode 12, from 0.25% to 5% of the positive electrode 12, or from 0.25% to 2.5% of the positive electrode 12. In aspects, the graphene sheet stacks 38 may account for, by weight, about 0.6% of the positive electrode 12.

Without intending to be bound by theory, it is believed that the graphene sheet stacks 38 may provide the positive electrode 12 with improved medium and/or long-range electrical percolation and conductivity, as compared to that provided by the carbon particles 36 alone. In aspects where the graphene sheet stacks 38 are in the form of graphene nanoplatelets, the relatively large aspect ratio (as compared to the carbon particles 36) of the graphene nanoplatelets may allow for the formation of relatively long and less tortuous electrically conductive pathways within the positive electrode 12, which may enhance the electrical percolation and conductivity of the positive electrode 12. In aspects where the diameter of the graphene nanoplatelets is relatively large, as compared to the diameter of the positive electrode active material particles 32, the graphene nanoplatelets may create electrically conductive pathways within the positive electrode 12 that span across multiple positive electrode active material particles 32. In addition, it is believed that the relatively high porosity of the graphene nanoplatelets, as compared to that of the carbon particles 36, may allow for the formation of more efficient and/or direct electrically conductive paths throughout the positive electrode 12, which may improve the electrical percolation and conductivity of the positive electrode 12, without increasing the amount of electrically conductive carbon additives in the positive electrode 12 and thus without reducing the discharge capacity of the electrochemical cell 10. It is believed that, in some aspects, the graphene nanoplatelets may favor the formation of open pores 44 (over the formation of closed pores) within the porous structure of the positive electrode 12. Open pores 44 within the positive electrode 12 may enhance penetration of the electrolyte 18 into the porous structure of the positive electrode 12 and may increase the ionic conductivity of the positive electrode 12.

The carbon nanotubes 40 may be cylindrical in shape and may exhibit aspect ratios of greater than or equal to about 100, aspect ratios of greater than or equal to about 500, aspect ratios of greater than or equal to about 1000, or aspect ratios of about 3000, with diameters in a range of from 0.5 nanometers to 50 nanometers and lengths in a range of from 1 micrometer to 100 micrometers. In aspects, the carbon nanotubes 40 may exhibit lengths of about 5 micrometers. The carbon nanotubes 40 may exhibit a porosity of greater than about 97% and may be in the form of single-walled carbon nanotubes and/or multiwalled carbon nanotubes. The carbon nanotubes 40 may exhibit surface areas in a range of from 50 m²/g to 500 m²/g and electrical conductivities in a range of from 10² S/cm to 10⁶ S/cm. In aspects, the carbon nanotubes 40 may include one or more hydroxyl (—OH) functional groups and/or carboxyl (—COOH) functional groups, which may help uniformly disperse the carbon nanotubes 40 throughout the entire thickness of the positive electrode 12. The carbon nanotubes 40 may account for, by weight, from 0.05% to 5% of the positive electrode 12, from 0.05% to 3% of the positive electrode 12, or from 0.05% to 1% of the positive electrode 12. In aspects, the carbon nanotubes 40 may account for, by weight, about 0.1% of the positive electrode 12.

Without intending to be bound by theory, it is believed that the carbon nanotubes 40 may substantially improve the long-range electrical percolation and conductivity of the positive electrode 12, as compared to that provided by the carbon particles 36 and/or the graphene sheet stacks 38. Due to their relatively long length and exceptionally large aspect ratio (as compared to the carbon particles 36 and the graphene sheet stacks 38) the carbon nanotubes 40 may allow for the creation of relatively long and less tortuous electrically conductive pathways within the positive electrode 12, which may enhance the electrical percolation and conductivity of the positive electrode 12. In aspects where the lengths of the carbon nanotubes 40 is relatively large, as compared to the diameter of the positive electrode active material particles 32, the carbon nanotubes 40 may create electrically conductive pathways within the positive electrode 12 that span across multiple positive electrode active material particles 32. In addition, it is believed that the relatively high porosity of the carbon nanotubes 40 (as compared to that of the carbon black particles and the graphene nanoplatelets), may allow for the formation of more efficient and/or direct electrically conductive paths throughout the positive electrode 12, which may improve the electrical percolation and conductivity of the positive electrode 12, without increasing the amount of electrically conductive carbon additives in the positive electrode 12 and thus without reducing the discharge capacity of the electrochemical cell 10.

Without intending to be bound by theory, it is believed that the presently disclosed combination of electrically conductive carbon additive types 36, 38, 40 may provide the positive electrode 12 with improved short-, medium-, and long-range electrical percolation and conductivity, as compared to positive electrodes that include one or two types of electrically conductive carbon additives (e.g., carbon particles 36 and graphene sheet stacks 38; carbon particles 36 and carbon nanotubes 40; or graphene sheet stacks 38 and carbon nanotubes 40). The inventors of the present disclosure have discovered that, when the carbon particles 36 are in the form of carbon black and the graphene sheet stacks 38 are in the form of graphene nanoplatelets, the combination of the carbon black particles, graphene nanoplatelets, and carbon nanotubes 40 may provide the positive electrode 12 with reduced electrical resistance and reduced charge transfer resistance, while maintaining and, in some instances, improving the ionic conductivity of the positive electrode 12 (as compared to positive electrodes that do not include this trip of electrically conductive carbon additive types). These and other benefits will be readily appreciated by those of ordinary skill in the art in view of the forgoing disclosure and the attached claims.

The negative electrode 14 is formulated to store lithium ions by undergoing a reduction reaction during charging of the electrochemical cell 10 and to release lithium ions by undergoing an oxidation reaction during discharge of the electrochemical cell 10 to compensate for the corresponding oxidation and reduction reactions occurring at the positive electrode 12 during operation of the electrochemical cell 10. The negative electrode 14 may include a negative electrode active material that can undergo a reversible redox reaction with lithium at a lower electrochemical potential than the positive electrode active material particles 32 of the positive electrode 12 such that an electrochemical potential difference exists between the positive electrode 12 and the negative electrode 14. For example, the negative electrode 14 may comprise an intercalation host material that is formulated to undergo the reversible insertion or intercalation of lithium ions. Or the negative electrode 14 may comprise a conversion material or an alloy material that can electrochemically alloy and form compound phases with lithium. Examples of negative electrode active materials for the negative electrode 14 include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, lithium oxide, metal oxides (e.g., iron oxide, cobalt oxide, manganese oxide, copper oxide, nickel oxide, chromium oxide, ruthenium oxide, and/or molybdenum oxide), metal phosphides, metal sulfides, and metal nitrides (e.g., phosphides, sulfides, and/or nitrides or iron, manganese, nickel, copper, and/or cobalt). Like the positive electrode 12, the negative electrode 14 also may comprise a polymeric binder and/or an electrically conductive carbon additive.

In aspects, the negative electrode 14 may be in the form of a nonporous layer of lithium metal. In such case, the negative electrode 14 may comprise a lithium metal alloy or may consist essentially of lithium (Li) metal. For example, the negative electrode 14 may comprise, by weight, greater than 97% lithium or greater than 99% lithium.

The porous separator 16 is configured to physically separate and electrically isolate the positive electrode 12 and the negative electrode 14 from one another while permitting lithium ions to pass therethrough. The porous separator 16 exhibits an open microporous structure and may comprise an organic and/or inorganic material that can physically separate and electrically insulate the positive and negative electrodes 12, 14 from each other while permitting the free flow of ions therebetween. The porous separator 16 may comprise a non-woven material, e.g., a manufactured sheet, web, or mat of directionally or randomly oriented fibers. The porous separator 16 may comprise a microporous polymeric material, e.g., a microporous polyolefin-based membrane or film. For example, the porous separator 16 may comprise a single polyolefin or a combination of polyolefins, such as polyethylene (PE), polypropylene (PP), polyamide (PA), poly(tetrafluoroethylene) (PTFE), polyvinylidene fluoride (PVdF), and/or poly(vinyl chloride) (PVC). In aspects, the porous separator 16 may comprise a laminate of one or more polymeric materials, such as a laminate of PE and PP.

The electrolyte 18 is ionically conductive and provides a medium for the conduction of lithium ions through the porous separator 16 and between the positive electrode active material particles 32 of the positive electrode 12 and the negative electrode active material of the negative electrode 14. The electrolyte 18 may be in the form of a liquid, solid, or gel that infiltrates the pores of the positive and negative electrodes 12, 14 and the porous separator 16. For example, the electrolyte 18 may comprise a nonaqueous liquid electrolyte solution including one or more lithium salts dissolved in a nonaqueous aprotic organic solvent or a mixture of nonaqueous aprotic organic solvents. Examples of lithium salts include lithium hexafluorophosphate (LiPF₆), lithium perchlorate (LiClQ₄), lithium tetrachloroaluminate (LiAlCl₄), lithium iodide (Lil), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof. In embodiments where the electrolyte 18 is in the form of a solid, the electrolyte 18 may function as both an electrolyte and a separator and may eliminate the need for a discreate separator 16.

The positive and negative electrode current collectors 22, 26 may be in the form of thin and flexible porous or non-porous electrically conductive substrates and may comprise a metallic material that is capable of collecting and reversibly passing free electrons to and from their respective electrodes 12, 14. The term “metallic,” as used herein, refers to a material that predominantly comprises one or more metals. As such, a metallic material may comprise a single metal, more than one metal (in alloy form or otherwise), or both one or more metals and one or more other non-metal components in elemental or compound form. For example, the positive and negative electrode current collectors 22, 26 may comprise an electrically conductive metal or metal alloy, e.g., a transition metal or an alloy thereof. In aspects, the positive electrode current collector 22 may comprise aluminum (Al), nickel (Ni), or an iron (Fe) alloy (e.g., stainless steel), and the negative electrode current collector 26 may comprise copper (Cu), nickel (Ni), an iron (Fe) alloy (e.g., stainless steel), or titanium (Ti). Other electrically conductive metallic materials may of course be used, if desired.

In a method of manufacturing the positive electrode 12, a slurry may be prepared. The slurry may be in the form a suspension including the positive electrode active material particles 32, the binder 34, the dispersant, the combination of electrically conductive carbon additive types (the carbon particles 36, the graphene sheet stacks 38, and the carbon nanotubes 40), and a solvent. The slurry may have a solids content of, by weight, greater than 55%, or about 65%. In aspects, the slurry may be prepared sequentially by: (1) mixing the electrically conductive carbon additive types with a solvent (e.g., N-methylpyrrolidone) to form a first mixture, (2) adding the binder 34 to the first mixture to form a second mixture, (3) adding the positive electrode active material particles 32 to the second mixture to form a third mixture, and then (4) mixing the third mixture with additional solvent to form a slurry exhibiting a desired viscosity.

The slurry may be deposited or cast onto an electrically conductive metallic substrate to form a precursor layer. The precursor layer may be dried in a vacuum oven at a temperature in a range of from about 50° C. to about 120° C. to evaporate at least a portion of the solvent and form a positive electrode precursor having a porosity in a range of from about 45% to about 60%. Thereafter, the positive electrode precursor may be calendered to form the final positive electrode 12 having a porosity in a range of from about 20% to about 35%.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A positive electrode comprising:
positive electrode active material particles;
a polymeric binder;
a polymeric dispersant; and
a combination of electrically conductive carbon additive types, the combination of electrically conductive carbon additive types including carbon particles, graphene sheet stacks, and carbon nanotubes.

2. The positive electrode of claim 1 wherein the carbon particles comprise particles of carbon black and/or acetylene black, and wherein the carbon particles exhibit a mean particle diameter in a range of from 2 nanometers to 100 nanometers.

3. The positive electrode of claim 1 wherein the carbon nanotubes include single-walled carbon nanotubes and/or multiwalled carbon nanotubes, and wherein the carbon nanotubes include hydroxyl (—OH) functional groups and/or carboxyl (—COOH) functional groups.

4. The positive electrode of claim 1 wherein the graphene sheet stacks comprise graphite flakes, and wherein the graphite flakes exhibit an aspect ratio in a range of from 1 to 3.

5. The positive electrode of claim 1 wherein the graphene sheet stacks comprise graphene nanoplatelets.

6. The positive electrode of claim 5 wherein the carbon particles exhibit an aspect ratio of about one, the graphene nanoplatelets exhibit an aspect ratio of greater than 20, and the carbon nanotubes exhibit an aspect ratio of greater than 100.

7. The positive electrode of claim 1 wherein the combination of electrically conductive carbon additive types accounts for, by weight, 0.5% to 10% of the positive electrode.

8. The positive electrode of claim 1 wherein the carbon particles account for, by weight, 0.25% to 10% of the positive electrode, the graphene sheet stacks account for, by weight, 0.1% to 10% of the positive electrode, and the carbon nanotubes account for, by weight, 0.05% to 5% of the positive electrode.

9. The positive electrode of claim 1 wherein the polymeric binder comprises polyvinylidene fluoride, and wherein the polymeric binder accounts for, by weight, 0.5% to 10% of the positive electrode.

10. The positive electrode of claim 1 wherein the polymeric dispersant comprises at least one polymer selected from the group consisting of a polytetrafluoroethylene and polyvinylidene fluoride copolymer, a sulfophenylated terphenylene copolymer, polyvinylpyrrolidone, or polyvinylpyridine, and wherein the polymeric dispersant accounts for, by weight, 0.1% to 10% of the positive electrode.

11. The positive electrode of claim 1 wherein the positive electrode active material particles comprise at least one metal oxide selected from the group consisting of lithium nickel manganese cobalt oxide, lithium manganese oxide, lithium nickel cobalt manganese aluminum oxide, lithium iron phosphate, or lithium manganese iron phosphate, the positive electrode active material particles exhibit a mean particle diameter in a range of from 0.2 micrometers to 25 micrometers, and wherein the positive electrode active material particles account for, by weight, 70% to 98.9% of the positive electrode.

12. An electrochemical cell for a lithium battery, the electrochemical cell comprising:
a positive electrode disposed on a major surface of a positive electrode current collector, the positive electrode including:
positive electrode active material particles;
a polymeric binder;
a polymeric dispersant; and
a combination of electrically conductive carbon additive types, the combination of electrically conductive carbon additive types including carbon black particles, graphene nanoplatelets, and carbon nanotubes,
wherein the positive electrode active material particles, the polymeric binder, the polymeric dispersant, and the combination of electrically conductive carbon additive types are substantially homogenously distributed throughout the positive electrode.

13. The electrochemical cell of claim 12 wherein the carbon black particles exhibit an aspect ratio of about one, the graphene nanoplatelets exhibit an aspect ratio of greater than 20, and the carbon nanotubes exhibit an aspect ratio of greater than 100.

14. The electrochemical cell of claim 12 wherein the carbon black particles account for, by weight, 0.25% to 10% of the positive electrode, the graphene nanoplatelets account for, by weight, 0.1% to 10% of the positive electrode, and the carbon nanotubes account for, by weight, 0.05% to 5% of the positive electrode.

15. The electrochemical cell of claim 12 wherein the polymeric binder comprises polyvinylidene fluoride, and wherein the polymeric binder accounts for, by weight, 0.5% to 10% of the positive electrode.

16. The electrochemical cell of claim 12 wherein the polymeric dispersant comprises at least one polymer selected from the group consisting of a polytetrafluoroethylene and polyvinylidene fluoride copolymer, a sulfophenylated terphenylene copolymer, polyvinylpyrrolidone, or polyvinylpyridine, and wherein the polymeric dispersant accounts for, by weight, 0.1% to 10% of the positive electrode.

17. The electrochemical cell of claim 12 wherein the positive electrode active material particles comprise at least one metal oxide selected from the group consisting of lithium nickel manganese cobalt oxide, lithium manganese oxide, lithium nickel cobalt manganese aluminum oxide, lithium iron phosphate, or lithium manganese iron phosphate, and wherein the positive electrode active material particles account for, by weight, 70% to 98.9% of the positive electrode.

18. The electrochemical cell of claim 12 wherein the positive electrode current collector comprises aluminum, the positive electrode is disposed on the major surface of the positive electrode current collector in the form of a continuous layer, the positive electrode exhibits a porous structure including a plurality of open pores, and the open pores of the positive electrode are infiltrated with an ionically conductive nonaqueous liquid electrolyte.

19. An electrochemical cell for a lithium battery, the electrochemical cell comprising:
a positive electrode disposed on a major surface of a positive electrode current collector, the positive electrode exhibiting a porous structure and including a plurality of open pores;
a negative electrode spaced apart from the positive electrode; and
an electrolyte infiltrating the open pores of the positive electrode, the electrolyte providing a medium for conduction of lithium ions between the positive electrode and the negative electrode,
wherein the positive electrode includes:
positive electrode active material particles including at least one metal oxide selected from the group consisting of lithium nickel manganese cobalt oxide, lithium manganese oxide, lithium nickel cobalt manganese aluminum oxide, lithium iron phosphate, or lithium manganese iron phosphate;
a polymeric binder including polyvinylidene fluoride;
a polymeric dispersant including at least one polymer selected from the group consisting of a polytetrafluoroethylene and polyvinylidene fluoride copolymer, a sulfophenylated terphenylene copolymer, polyvinylpyrrolidone, or polyvinylpyridine; and
a combination of electrically conductive carbon additive types, the combination of electrically conductive carbon additive types including carbon black particles, graphene nanoplatelets, and carbon nanotubes,
wherein the combination of electrically conductive carbon additive types accounts for, by weight, 0.5% to 10% of the positive electrode.

20. The electrochemical cell of claim 19 wherein the negative electrode is disposed on a major surface of a copper current collector, the negative electrode comprises graphite, silicon, or a nonporous lithium metal layer, the positive electrode current collector comprises aluminum, and wherein the electrolyte is an ionically conductive nonaqueous liquid solution including a lithium salt dissolved in a nonaqueous aprotic organic solvent.
